(19) United States
(12) Patent Application Publication
(10) Pub. No.: US 2001/0026316 A1
(43) Pub. Date: Oct. 4, 2001

(54) Multi-observation and recording system for various modes of transportation

(76) Inventor: John P. Senatore, Westville, NJ (US)

Correspondence Address: NORMAN E. LEHRER, 1205 North Kings Highway, Cherry Hill, NJ, 08034, US

(21) Appl. No.: 09/791,656

(22) Filed: Feb. 26, 2001

Related U.S. Application Data
(63) Continuation-in-part of application No. 09/422,324, filed on Oct. 21, 1999.
(60) Provisional application No. 60/126,468, filed on Mar. 26, 1999.

(51) Int. Cl. H04N 7/18; H04N 9/47

(52) U.S. Cl. 348/148; 348/144; 348/158

(57) ABSTRACT

A system which includes a housing having a video camera removably mounted to the control or instrument panel of an airplane, train, or boat is disclosed. The camera records the airway, track, or waterway in front of the airplane, train, or boat, respectively. The camera focuses on the airway, track, or waterway in front of the vehicle and includes three additional lenses where each additional lens is focused on a different view. That is, the first lens is focused on the operator, the second lens is focused on one part of the instrument panel that may show speed or altitude or the like, and the third lens is focused on another part of the panel that may display other relevant information. The system is wired into the airplane, train, or boat so that when it is turned on the camera is activated. A recording unit is located in the airplane, train, or boat in a waterproof and/or fireproof housing. The recording unit includes a cassette tape, disc, or chip. A key-lock prevents the unauthorized removal of the tape. As video images are received from the camera, the date and time are superimposed on the recorded image by a time and date generator that is always running regardless of the operation of the airplane, train, or boat. A button on the housing allows the operator to retrieve the last ten minutes of the tape. The present invention also includes an output jack which allows authorized personnel to retrieve the last fifteen minutes of the tape via a separate mini recorder.

### CROSS-REFERENCE TO RELATED APPLICATIONS

This application is a Continuation-In-Part of pending U.S. patent application Ser. No. 09/422,324 filed Oct. 21, 1999 which claims the benefit of U.S. Provisional Patent Application Ser. No. 60/126,468, filed on Mar. 26, 1999.

### BACKGROUND OF THE INVENTION

The present invention is directed toward a recording system for various modes of transportation and more particularly, toward a system for recording the conditions in front of a motor vehicle, airplane, train, or boat and for simultaneously recording the operator and dashboard or instrument panel of the vehicle, train, plane, or boat.

Today more than ever, there is a need for a device to record a driver of a motor vehicle, the odometer, speedometer, time, date, and traffic conditions in front of the vehicle. This need arises out of the fact that more and more drivers behave poorly while driving and need to be held accountable for their actions on the road. That is, the actions of the driver may be needed to be observed and recorded in order to discourage road rage, speeding, kidnapping, reckless driving, car jacking, driving under the influence of drugs or alcohol, careless driving, etc. Presently, there is no known assembly or device which can provide this type of record.

### SUMMARY OF THE INVENTION

It is an object of the present invention to record the exact time, date, speed, mileage of a motor vehicle, the driver of the vehicle, and the conditions in front of the vehicle.

It is also an object of the present invention to record the instrument or control panel of a vehicle including an airplane, train, or boat.

It is another object of the present invention to record the operator of a vehicle including an airplane, train, or boat.

It is a further object of the present invention to record the conditions in front of an airplane, train, or boat.

In accordance with the illustrative embodiments demonstrating features and advantages of the present invention, there is provided in a first embodiment a system which includes a housing having a video camera removably mounted to the dashboard of a motor vehicle. The camera records the road in front of the vehicle. The camera also includes three lenses where each lens is focused on a different view. That is, the first lens is focused on the driver, the second lens is focused on the odometer, and the third lens is focused on the speedometer. The system is wired into the vehicle so that when the vehicle is turned on the camera is activated. A recorder is located in the trunk of the vehicle in a fireproof housing. The recorder includes means for storing the images observed by the camera such as a cassette tape, disc, or chip. A key-lock prevents the unauthorized removal of the storing means. As video images are received from the camera, the date and time are superimposed on the recorded image by a time and date generator that is always running regardless of the operation of the vehicle. A button on the housing allows the driver to retrieve the last ten minutes of the tape. Another feature of the present invention is an output jack which allows authorized personnel, such as a police officer to retrieve the last fifteen minutes of the tape via a separate recording device held by the police officer.

In further embodiments of the present invention, the device may be used on an airplane, train, or boat to record similar information.

Other objects, features, and advantages of the invention will be readily apparent from the following detailed description of preferred embodiments thereof taken in conjunction with the drawings.

### BRIEF DESCRIPTION OF THE DRAWINGS

For the purpose of illustrating the invention, there is shown in the accompanying drawings forms which are presently preferred; it being understood that the invention is not intended to be limited to the precise arrangements and instrumentalities shown.

FIG. 1 is a cut away, side view of the recording system of the present invention located within a motor vehicle;

FIG. 2 is a front elevational view of the camera of the present invention installed on a dashboard of a vehicle;

FIG. 3 is an illustration of a police officer carrying a mini recorder of the present invention;

FIG. 4 is a front elevational view of the mini recorder of the present invention which is used by authorized personnel;

FIG. 5 is a side elevational view of the mini recorder of the present invention with a male output jack hookup and a clip used to attach the recorder to the belt of a person;

FIG. 6 illustrates the present invention being used on an airplane;

FIG. 7 illustrates the present invention being used on a train, and

FIG. 8 illustrates the present invention being used on a boat.

### DETAILED DESCRIPTION OF THE PREFERRED EMBODIMENTS

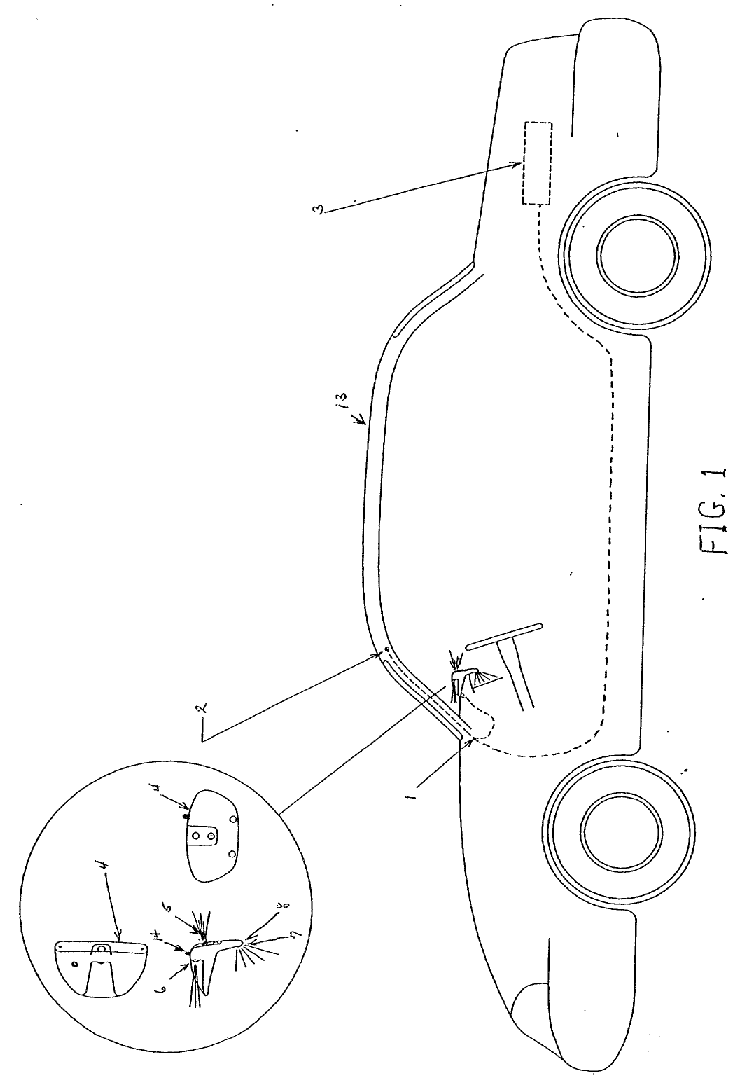

Referring now to the drawings in detail wherein like reference numerals have been used throughout the various figures to designate like elements, there is shown in FIG. 1 a recording system constructed in accordance with the principles of the present invention.

The present invention essentially includes a housing 4 which is removably mounted to the dashboard of a motor vehicle 13, behind the steering wheel. The housing 4 may be mounted by a heavy duty adhesive to a mounting bracket where the bracket is secured to the vehicle. The housing 4 includes a camera 6 with three additional lenses 5, 7, and 8 all in one compact unit. The housing also has a button 14. The purpose of the button 14 will be discussed in greater detail below. Camera 6 focuses on the view in front of the vehicle 13 and observes all that the driver sees. The first lens 5 focuses on the driver, the second lens 7 focuses on the speedometer, and the third lens 8 focuses on the speedometer. (See FIG. 2.)

A recording unit 3 is located within the trunk of the vehicle and is electrically attached via wiring 1 to the camera 6. (See FIG. 1.) The recording unit 3 may be stored within a fireproof housing which is attached to the floor of the trunk via a bracket. A video cassette, disc, or chip may be the means for recording or storing the images observed. The recording unit 3 is a standard recorder that pulls in the cassette or disc and places it into position for recording or playing and has a standard set of controls of a video recorder including an eject button, a pause button, a rewind button, and so on. A key-lock prevents unauthorized removal of the image storing means from the recording unit 3. The images taken from the camera 6 and the three lenses 5, 7, and 8 will be shown as one recorded image along with the time and date being superimposed on the recorded image via a time and date generator that is always running regardless of the operation of the vehicle. The time and date will appear in the upper right corner of the image. Also, the recording unit 3 has a separate disc, tape or chip for information to be saved and a button for saving the data. Button 14 may be used by the driver to retrieve the last ten minutes of recorded events.

A female output jack 2 is located on the exterior of the vehicle 13 and is connected to the recording unit 3 via wiring 1. The jack 2 may be used by authorized personnel. The last fifteen minutes of recording may be retrieved. This output jack 2 may be placed anywhere two inches over the driver's side door and between the front window and the rear end of the driver's door. The female output jack 2 is activated only when the vehicle is in operation, that is, it is dependent upon the electrical source of the vehicle 13.

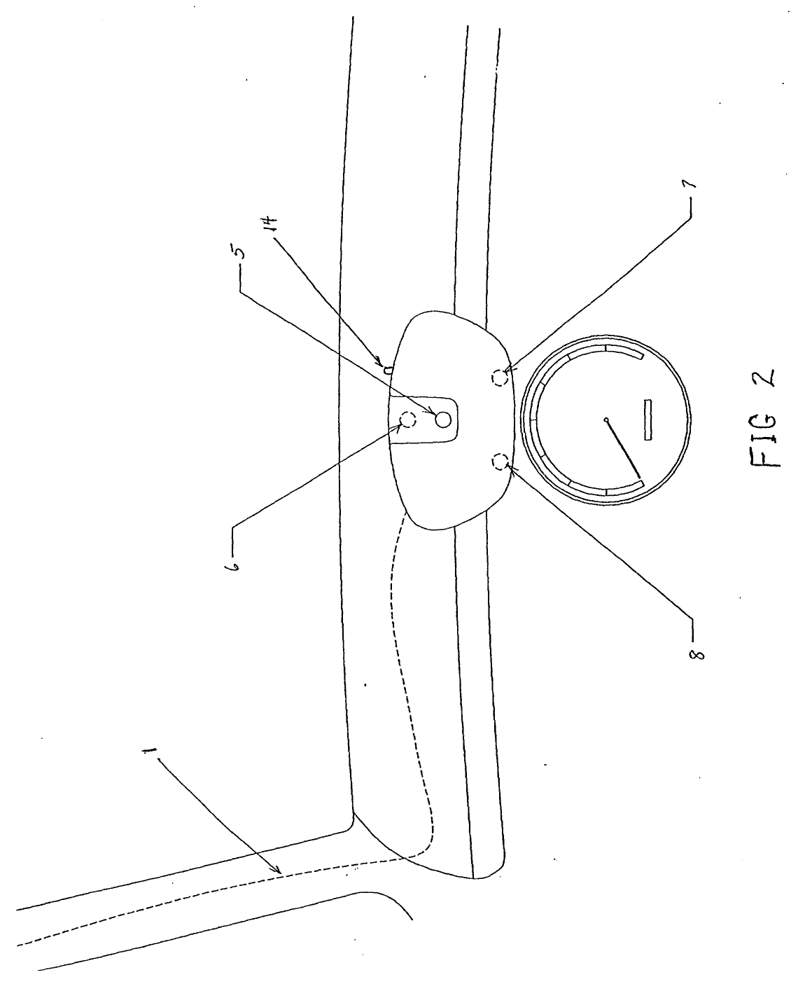

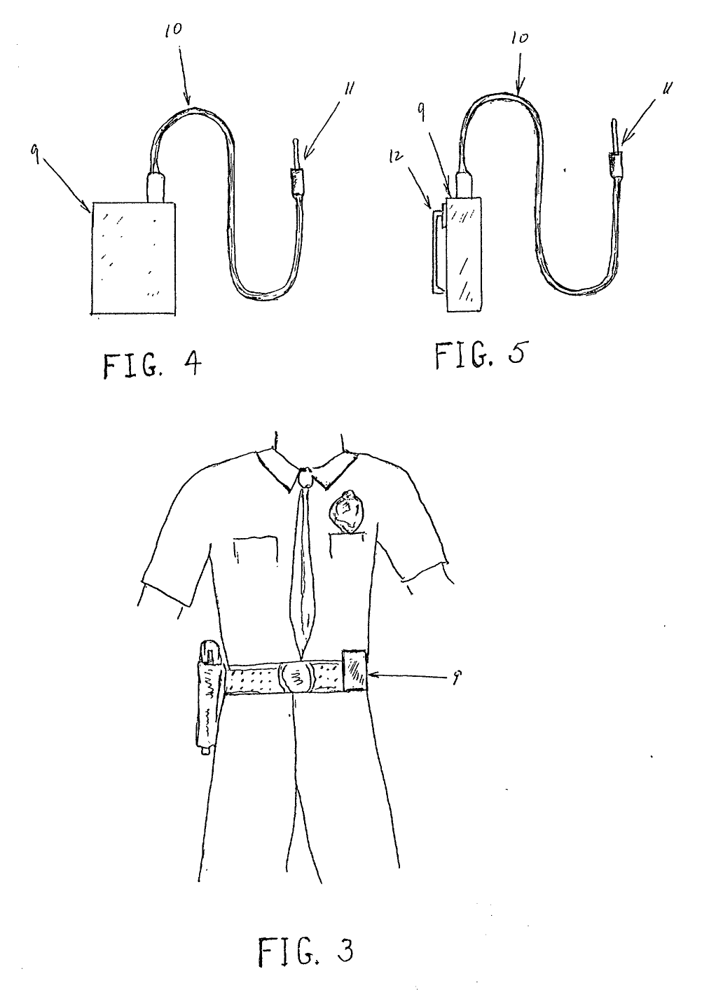

The present invention also includes a mini recorder 9. The mini recorder 9 is worn by authorized personnel, such as a police officer. (See FIG. 3.) The mini recorder 9 is used to retrieve the last fifteen minutes or more of recorded images and may be used by the police as needed. The mini recorder 9 is of standard design and has a male jack coupler 11 which is connected to the mini recorder 9 via wire 10. (See FIG. 4.) The mini recorder 9 may be connected to the belt of a police office via connector 12, thereby making the mini recorder 9 portable. (See FIG. 5.) The plug 11 can be plugged into the jack 3.

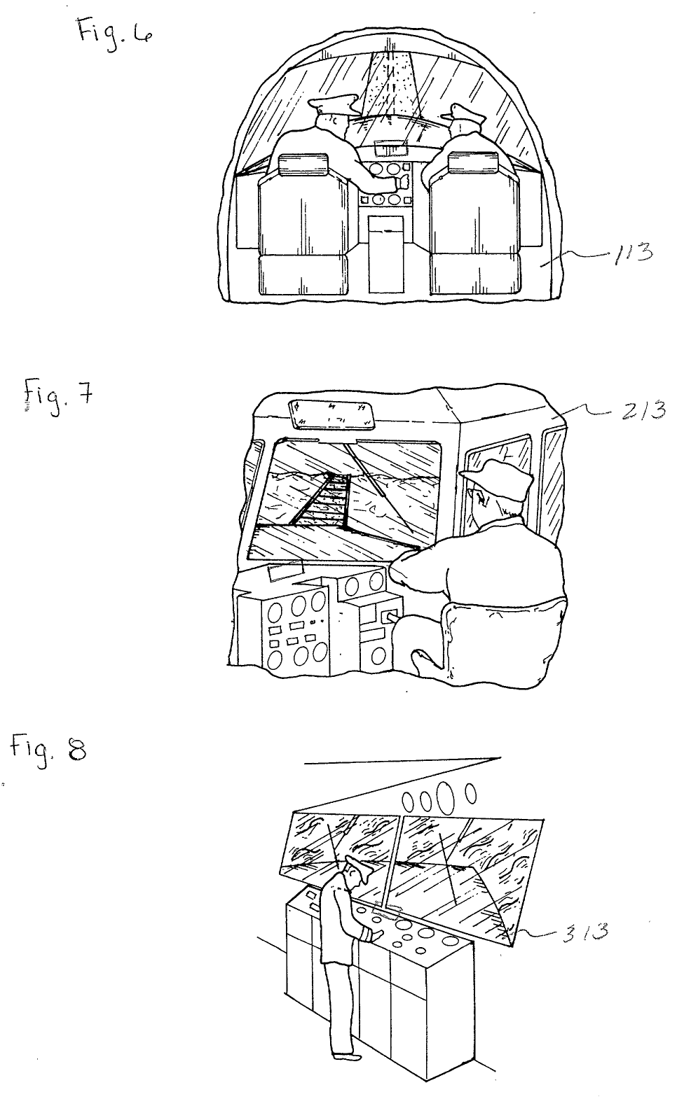

Further embodiments of the present invention are shown in FIGS. 6-8. That is, the present invention may also be used to record the instrument or control panel of an airplane 113 (FIG. 6), a train 213 (FIG. 7), or a boat 313 (FIG. 8). The device may be used to record the operator or pilot of the airplane, train, or boat as well as the airspace, track, or waterway in front of the airplane, train, or boat, respectively. The device functions in the same manner described above and, accordingly, the description will not be repeated here.

The use of the present invention in airplanes, trains, and boats may be particularly useful in the analysis of accidents or crashes. That is, the conditions in front of the airplane, train, or boat as well as the driver and instrument panel are recorded so that whatever error or malfunction which may have occurred can be observed. Obviously, to accomplish the foregoing, modifications will have to be made to the primary invention described above when the same is used with an airplane, train or boat. By way of example and not limitation, when used with a boat, the recorder will be housed in a waterproof container which is capable of floating. Similarly, when used with an airplane, the recorder will preferably be contained in a “black box.”

The present invention may be embodied in other specific forms without departing from the spirit or essential attributes thereof and accordingly, reference should be made to the appended claims rather than to the foregoing specification as indicating the scope of the invention.

I claim:

1. An observation and recording system for an airplane comprising:
camera means carried by the airplane, said camera means being directed at the airspace in front of the airplane and the pilot of the airplane and
means for recording images of the airspace in front of the airplane and of the pilot of the airplane observed by said camera means.

2. The observation and recording system for an airplane of claim 1 further including means for recording information from the instrument panel of the airplane.

3. The observation and recording system for an airplane of claim 2 wherein said information is provided by said camera means.

4. An observation and recording system for a train comprising:
camera means carried by the train, said camera means being directed at the track in front of the train and the operator of the train and
means for recording images of the track in front of the train and of the operator of the train observed by said camera means.

5. The observation and recording system for a train of claim 4 further including means for recording information from the instrument panel of the train.

6. The observation and recording system for a train of claim 5 wherein said information is provided by said camera means.

7. An observation and recording system for a boat comprising:
camera means carried by the boat, said camera means being directed at the waterway in front of the boat and the operator of the boat and
means for recording images of the waterway in front of the boat and of the operator of the boat observed by said camera means.

8. The observation and recording system for a boat of claim 7 further including means for recording information from the instrument panel of the boat.

9. The observation and recording system for a boat of claim 8 wherein said information is provided by said camera means.
